(19) United States
(12) Patent Application Publication
(10) Pub. No.: US 2003/0069721 A1
(43) Pub. Date: Apr. 10, 2003

(54) Computational method for determining oral bioavailability

(75) Inventor: Brent L. Podlogar, Hamden, CT (US)

Correspondence Address: LAHIVE & COCKFIELD, 28 STATE STREET, BOSTON, MA, 02109, US

(73) Assignee: Paratek Pharmaceuticals, Inc., Boston, MA

(21) Appl. No.: 10/241,308

(22) Filed: Sep. 10, 2002

Related U.S. Application Data
(60) Provisional application No. 60/318,580, filed on Sep. 10, 2001.

(51) Int. Cl. G06G 7/48; G06G 7/58

(52) U.S. Cl. 703/11; 703/12

(57) ABSTRACT

A method for determining oral bioavailibility based on the linear regression computer program, SIMCA (Soft Independent Modelling of Class Analogy) is described.

### RELATED APPLICATIONS

This application claims priority to U.S. S. No. 60/318,580, entitled “Computational Method for Determining Oral Bioavailability,” filed on Sep. 10, 2001, the entire contents of which are hereby incorporated herein by reference.

### BACKGROUND OF THE INVENTION

Starting with the serendipitous discovery of penicillin by Fleming and the subsequent directed searches for additional antibiotics by Waksman and Dubos, the field of drug discovery during the post World War II era has been driven by the belief that nature would provide many needed drugs if only a careful and diligent search for them was conducted. Consequently, pharmaceutical companies understood massive screening programs which tested samples of natural products (typically isolated from soil or plants) for their biological properties. In a parallel effort to increase the effectiveness of the discovered “lead” compounds, medicinal chemists leamed to synthesize derivatives and analogs of the compounds. Over the years, as biochemist's identified new enzymes and biological reactions, large scale screening continued as corn pounds were tested for biological activity in an ever rapidly expanding number of biochemical pathways. However, proportionately fewer and fewer lead compounds possessing a desired therapeutic activity have been discovered. In an attempt to extend the range of compounds available for testing, during the last few years the search for unique biological materials has been extended to all corners of the earth including sources from both the topical rain forests and the ocean. Despite these and other efforts, it is estimated that discovery and development of each new drug still takes about 12 years and costs on the order of 350 million dollars.

In the quest for novel and improved chemotherapeutics, percent oral bioavailability, (% OB) is one of many pharmacokinetic and pharmacodynamic parameters which require optimization During the course of a typical drug discovery project, considerable resources: human effort, financial resources, time must be “front-loaded” into an inherently risky process before indications of a drug candidate's viability can be experimentally assessed. This important parameter is often the very parameter that makes or breaks project success: delivery of a pre-clinical drug candidate. Because of the cost and resources required to bring one candidate to the point where % OB can be experimentally determined, the scientific method, i.e. iterations of proposing, testing and modifying a working hypothesis, is simply not feasible. In addition to these practical difficulties, oral bioavailability is a complex parameter that is related to the physico-chemical properties of a candidate molecule, e.g., dissolution, membrane transport, chemical stability, etc. as well as the intricate interactions it has with the host, e.g., metabolic fate, distribution, clearance. In silico methods represent the only means to provide information on oral bioavailability at the initial stages of the drug discovery program.

The specific requirements of computational methods for use in a pharmaceutical industrial setting differ vastly from those applied in an academic environment. Factors including availability of the algorithms, ease of implementation and application, the degree to which expert support is required, data formatting/handling and the ease with which the results are understood and interpreted are all of a practical importance.

### SUMMARY OF THE INVENTION

In an embodiment, the invention pertains, at least in part, to a method for determining the oral bioavailablity of a test molecule. The method includes providing at least one descriptor for the test molecule, and allowing SIMCA to determine the classification of the test molecule.

In further embodiments, the method can be repeated at least once for each molecule of a chemical library, such that the compounds with advantageous oral bioavailbilities can be identified.

### DETAILED DESCRIPTION OF THE INVENTION

The invention pertains at least in part, to a method for determining the oral bioavailable of a test molecule using linear regression calculation methods, such as the computer program SIMCA (Soft Independent Modelling of Class Analogy). The method includes providing at least one descriptor for a test molecule, and allowing SIMCA to determine the classification of the test molecule.

The term “SIMCA” is an acronym for Soft Independent Modelling of Class Analogy (Wold, J. Pattern Recogn., 8:127 (1976); Wold, S. Analysis of Chemical Data in Terms of Analogy and Similarity. in Proc. First Int. Symp. on Data Analysis and Informatics, Versailles, France 1977). SIMCA is a program which takes a precategorized training set and for each category in turn, models the members of that category by the principal components of the explanatory data for that category (Hunt, P.A. QSAR using 2D Descriptors and TRIPOS' SIMCA, J. Comp.—Aided Mol. Design 1999, Volume 13, p. 453-457).

SIMCA and other in silico, or computer based methods, are a comparably inexpensive method to avert the costly and time consuming laboratory experiments needed to determine oral bioavailability in the laboratory. In principle, most in silico methods can be reduced to three steps: accumulation-data input, manipulation-model derivation, and presentation-impact on decision making. Accumulation of the experimentally known data involves collecting the relevant data. Once the data is gathered, it is manipulated and reformatted using a variety of methods, such that it is possible to distinguishes the compounds with advantageous oral bioavailabilities.

The term “oral bioavailability” (“% OB”) includes, generally, the degree to which a drug or other substance becomes available to a target tissue after oral administration. Despite the importance of oral bioavailability to drug studies and pharmaceutical companies, very few studies have been conducted toward the development of useful computational models that estimate this parameter. One limitation has been the availability of a suitably robust data set, due to technical difficulties in attaining experimental data. In a further embodiment, the oral bioavailability of the of the training compounds may be the oral bioavailability to a particular target tissue. For example, in an embodiment, the particular target tissue may require traversal of the blood brain barrier (BBB), therefore the training set may use oral bioavailability data from this particular target tissue.

The term “target tissue” includes any tissue or body fluid of a subject, preferably human, to which it is desirable to deliver an orally administered drug. For example, the target tissue may be the brain, blood, nerves, spinal cord, heart, liver, kidneys, stomach, muscles, lung, pancreas, intestine, bladder, reproductive organs, bones, tendons, or other internal organs or tissues.

Experimental oral bioavailability determinations require substantial amounts of purified material, a series of pharmokinetic experiments to determine the overall exposure and routes of elimination, and determination of serum/tissue time-concentration profiles determined when the drug candidate is administered via O.P. administration and iv administration (Grass, G. M. Adv Drug Delivery Rev 1997, 23, 199-219). Since compound availability and human in vivo subjects are limiting, alternative animal models, mouse, rat, dog, are typically employed. Furthermore, there exist substantial differences in the mechanisms which determine oral bioavailability for mice, rats, dogs and humans, further complicating the issue (for example, see, Mathvink, et al Mathvink, R. J et al. J. Med. Chem. 2000, 43, 3832-3836) Oral bioavialibility can be determined according to the Equation 1 (Borchardt, R. T. The Scientist 2001, 15, 43-46):

% OB=% F=(AUC)_{p o.}/(AUC)_{i. v.}×(Dose)_{i v.}/(Dose)_{p o} (I)

In this equation, % OB is the percent oral bioavailibility and %F is the fraction absorbed. AUC is the experimentally determined “area under the curve” and is related to other pharmacodynamic parameters such as clearance (CL), volume of distribution (V_{d}), and elimination half-life (t_{1/2}) (See Hirono, S. et al. Biol Pharm Bull 1994, 17, 306-309).

The term “classification” refers to the method by which the test compounds with high oral bioavailability are distinguished from those with more questionable bioavailability and those which are not considered to be orally bioavailable. The classification may further be divided into additional or fewer classes as is appropriate for a given situation or group of test compounds. Generally, the classification is derived from a training set of compounds whose bioavailability for a particular tissue is either known or can be experimentally or other wise determined. The oral bioavailability of the compounds in the training set in combination with one or more descriptors is used by the linear regression program, e.g., SIMCA, to determine a relationship between the descriptors entered and the oral bioavailabilities. Once a relationship between the descriptors and the oral bioavailabilities of the compounds is determined, the set is divided up into two or more categories and then may be used to predict the oral bioavailibilities of test compounds.

The term “training set” refers to a group of compounds with known oral bioavailibilities. One example of a training set of compounds is given in Table 1. It should be noted that other training sets may be used to develop other classification groupings. Furthermore, in certain embodiments, the oral bioavailibilities of the compounds in the training set may reflect a particular tissue of interest, e.g., tissues which are blood accessible or tissues which require traversal of the blood brain barrier. Generally, the training set comprises enough compounds such that it is capable of performing its intended function. In a further embodiment, the training set comprises 10, 20, 30, 50, 100, 150, 200, or 300 or more compounds.

The term “descriptor” includes a values corresponding to a calculable property or characteristic of a molecule and is usually derived from a 2-dimensional or 3-dimensional representation of the molecule.

In the methods of the invention, one, two, three, four, five, six, seven, eight, nine, ten, eleven, twelve, thirteen, fourteen, fifteen, sixteen, seventeen, eighteen, nineteen, twenty, twenty one, twenty two, twenty three, twenty four, twenty five, twenty six, twenty seven, twenty eight, twenty nine, thirty or more descriptors are used. The number of descriptors used for the classification of a particular test compound can be adjusted such that appropriate discrimination between the classes of compounds is determined. In one embodiment, the sum of the residual squares can be used as a measure to determine an appropriate number of descriptors.

The model is derived from a set of molecules referred to as the training set. Once a model has been established, each member of the training set is evaluated according to the model and assigned a residual error value-an expression related to the difference between the value calculated by the model and the actual value. Following the sum of the residuals of the models provides a measure as to whether the modifications were benefical. In evaluating the sum of the residuals as a function of the total number of allowed components, a steady decrease is indicative of a “well-behaved” model.

SIMCA evaluates descriptors derived or otherwise produced by a variety of programs, such as SYBYL. Examples of descriptors which may be useful for determining oral bioavailability include, but are not limited, those which describe molecular orbitals such as polarizability and sums of point charges. Other descriptors which may be useful include atom counts of particular atoms of interest and functional group based descriptors.

In one embodiment, the descriptor VOL is used. VOL describes the molecular volume of the test compound.

In another embodiment, the descriptor ATOMS is used. ATOMS describes the total number or count of atoms in a particular test compound]

In another embodiment, the descriptor HHET is used. HHET is a molecular orbital descriptor which describes [the total number or count of hydrogen atoms in a particular test compound covalently bonded (attached) to heteroatoms including nitrogen (N), oxygen (O) or Sulfur (S).

In another embodiment, the descriptor P is used. P describes the number or count of phosphorous atoms in a particular test compound.

In another embodiment, the descriptor C is used. C describes the number or count of carbon atoms in a particular test compound.

In another embodiment, the descriptor HBH is used. HBH describes the number or count of hydrogen atoms in a particular test compound generally observed to form hydrogen bonds.

In another embodiment, the descriptor ZHHET is used. ZHHET is a molecular orbital descriptor describing the sum of point charges of the total number or count of covalently bonded hydrogen atoms to heteroatoms including nitrogen (N), oxygen (O) or Sulfur (S)

In another embodiment, the descriptor ZHBH is used. ZHBH is a molecular orbital descriptor describing the sum of point charges for the total number or count of hydrogen atoms in a particular test compound generally observed to form hydrogen bond.

In another embodiment, the descriptor ZH is used. ZH is a molecular orbital descriptor describing the sum of point charges for the total number or count of hydrogen atoms in a particular test compound.

In another embodiment, the descriptor MOB is used. MOB is a molecular orbital descriptor which describes the molecular orbital basicity of a particular compound.

In another embodiment, the descriptor EB is used. EB is a molecular orbital descriptor which describes the electronic basisity of a particular test compound; the minimal point charge of all atoms of a particular test compound.

In another embodiment, the descriptor H is used. H is an atom-based descriptor which describes the number or count of hydrogen atoms in a particular test compound.

In another embodiment, the descriptor O is used. O is an atom based descriptor which describes the number or count of oxygen atoms in a particular test compound.

In another embodiment, the descriptor HBD is used. HBD is a atom based descriptor which describes the number or count of any hydrogen bond donors present in the test compound.

In another embodiment, the descriptor ZATOMS is used. ZATOMS is a molecular orbital descriptor which describes the sum of point charges molecular orbitals of all the atoms in a particular test compound.

In another embodiment, the descriptor ZC is used. ZC is a molecular orbital descriptor which describes describes the sum of point charges for the total number or count of carbon atoms in a particular test compound.

Similarly, in another embodiment, the descriptor ZO is used. ZO is a molecular orbital descriptor which describes describes the sum of point charges for the total number or count of oxygen atoms in a particular test compound.

In another embodiment, the descriptor ZHBA is used. ZHBAis a molecular orbital descriptor which describes describes the sum of point charges for the total number or count of atoms in a particular test compound generally observed to behave as hydrogen bond acceptors.

In another embodiment, the descriptor ZHBD is used. . ZHBDis a molecular orbital descriptor which describes describes the sum of point charges for the total number or count of atoms in a particular test compound generally observed to behave as hydrogen bond donors.

In another embodiment, the descriptor MORPHOLINE is used. MORPHOLINE describes the number or count of morpholino rings in a particular test compound.

In another embodiment, the descriptor POLI is used. POLI is a molecular orbital descriptor which describes the polarizability of a particular test compound.

In another embodiment, the descriptor MOA is used. MOA is a molecular orbital descriptor which refers to the molecular orbital acidity of a particular test compound.

In other embodiments, the descriptors for any one or combination of N, F, or I are used. These are atom based descriptors and refer to the count or number of nitrogen, fluorine and iodine atoms, respectively, in a particular test compound.

In other embodiments, the descriptors for any one or combination of RING, HYDROXYL, or CF3 are used. These are functional-group based descriptors and refer to the count of 3-7 membered rings, hydroxyl groups, and trifluoromethyl groups, respectively, in a particular test compound.

In another embodiment, the descriptor HBA is used. HBA is a atom-based descriptor which describes the number or count of hydrogen bond accepting atoms in a particular test molecule.

In another embodiment, the descriptor ZN is used. ZN is a descriptor which describes sum of point charges for the total number or count of all nitrogen atoms in a particular test compound.

In another embodiment, the descriptor MLOGP is used. MLOGP is a molecule based descriptor which describes an estimation of the log of the octanol-water partion ratio according to the method of Moriguchi (Moriguchi, I. et al. Chem. Pharm. Bull. 1992, 40, 127-130).

In another embodiment, the descriptor EA is used. . EA is a molecular orbital descriptor which describes the electronic acidity of a particular test compound; the maximal point charge of all hydrogen atoms of a particular test compound.

In another embodiment, one or more of the following atom based descriptors are used: S, Cl, and Br. These atom based descriptors describe the number of sulfur, chlorine, and bromine atoms in particular test compounds, respectively.

In another embodiment, one or more of the following functional group-based descriptors are used: AMIDE, ACID, METHYL, METHOXY, PIPERDINE, PIPERAZINE, SULFONAMIDE, and PHENOL. Each of these functional group based descriptors refer to the number or count of their namesake functional groups. In an embodiment, the methods of the invention are capable of “scanning” a list of compounds, regardless of origin and structural group, and identifying test compounds with acceptable oral bioavailability and eliminating test compounds with poor oral bioavailability. In contrast to strategies that attempt to correctly predict the oral bioavailability at all ranges, the present method discriminates between the extremes of the training set. For example, in one embodiment, the compounds of the training set are stratified into three groups as shown in Table 1. For example, in the training set, the compounds are divided into 3 oral bioavailibility classes: 0-20%; Class 2, 21-79%; and Class 3, 81-100%. It should be noted that the test compounds can be classified into any number of categories and methods using two, three, four, five, six, seven, eight, nine, ten, eleven, etc. classes are included in certain embodiments of the invention.

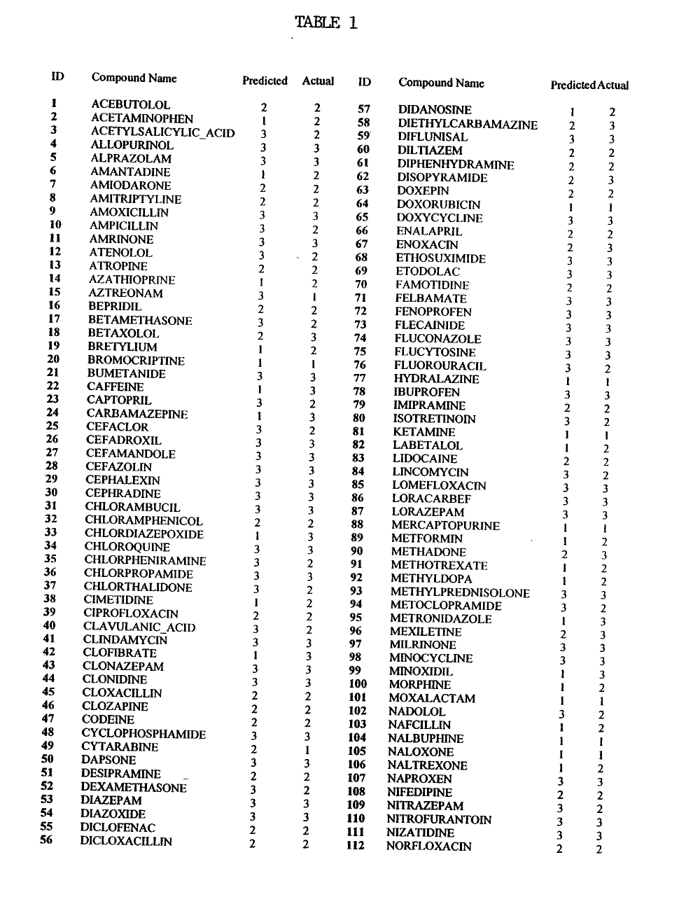

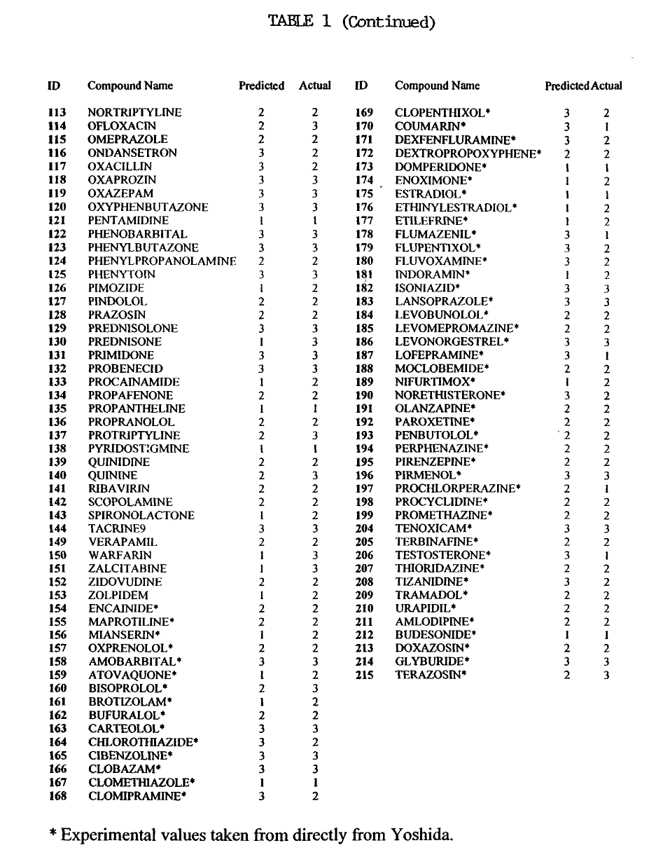

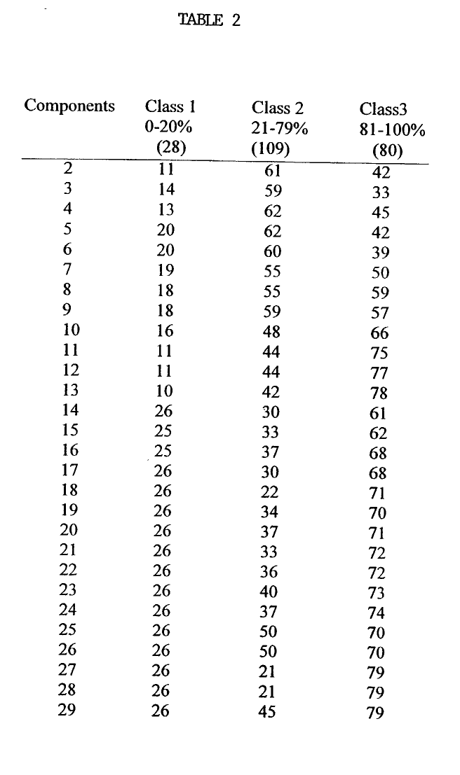

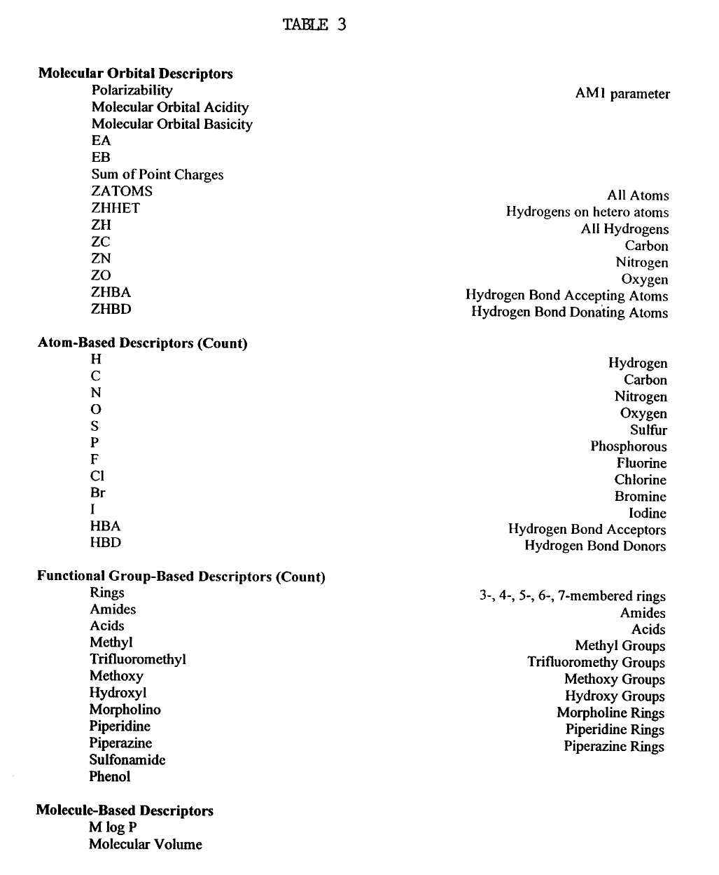

The method takes into account that the majority of the mis-categorizations, both in the fitting process as well as in the prediction process, will originate from those compounds with values close to the stratification demarcations, in the so-called “trouble regions” represented in gray. As designed, it is hoped that by inserting a large “buffer zone” represented by Class 2, a clear distinction between Class 1 and Class 3 can be easily attained. Therefore, a compound selection strategy of retaining only the class 3 predictions is proposed. As such, some model error is permissible as illustrated by the green arrows in FIG. 1. For instance, Class 1 predictions can be in error by one level, but will still be correctly eliminated form the list since they would be categorized as Class 2. Class 2 predictions, if correct or if underestimated to be Class 1, will likewise be eliminated. Class 2 predictions that are over-estimated to be Class 1, will likewise be eliminated. Class 2 predictions that are over-estimated as false positives are simply retained in the filtered list. Keeping the latter to a minimum will affect the magnitude of data reduction. Two instances of error that are not permissible, and must be minimized in the model selection, if possible, are the two-level over-estimations of Class 1 predictions, i.e. a compound with a low % OB predicted as a Class 3 member, and the alternative where Class 3 compounds are mis-categorized as false negatives-either Class 2 or Class 1.

Computational models were developed as an efficient screening tool to select compounds from lists generated from combinatorial chemistry and virtual libraries likely to possess high oral bioavailability (% OB). The models were constructed using Tripos' implementation of SIMCA from a training set of 215 known drugs categorized into 3 distinct groupings: 0-20% (Class 1), 21-79% (Class 2) and 80-100% (Class 3). The best models were verified on a test set of 52 known drugs. Descriptors utilized to develop the model are easily calculated by widely available means and include a combination of atom-, functional group- and molecule-based parameters. From a list of 43 descriptors, an 8 component model yielded exceptional discrimination, especially for Class 1 and Class 3 compounds at 64% and 73%, respectively. From the test set, 30 structures were predicted to be members of Class 3; of these, 18/19 were correctly identified correctly as being in Class 3. In a selection strategy where only Class 3 predictions are retained for further consideration, the application to the test set represents a significant reduction in data volume (42%) and a 24% enrichment of data set in compounds likely to possess high % OB (Class 3). Due to the ease of its implementation and application, this model can be used as a part of a suite of filtering tools that aids in selection and prioritization decisions in the drug discovery process. This and other in silico methods provide valuable a priori information that address late stage pharmacokinetic and pharmacodynamic parameters when they are needed the most-at the beginning of a drug discovery program when design decisions are being made.

The methods of the invention offer a practical in silico method to aid in the selection and prioritization efforts of compounds in an on-going drug discovery program. The methods use computational programs and scripts that are widely available to the general scientific community. The descriptors used are easily relatable to common understandings of the molecular mechanisms involved in the overall oral bioavailibility, and can be calculated by methods known in the art. The scripts and programs to create the descriptors and prepare the compounds are known in the art. Furthermore, the methods of the invention do not require pre-categorization steps according to compound structural type, as required by some other prior art methods. The final model reduces the total number of compounds on the order of 40%, and identified greater than 90% of compounds with high oral bioavailability.

### EXEMPLIFICATION OF THE INVENTION

In this study, a training set of 215 known drugs with experimentally determined human oral bioavailability was used to develop an in silico screening tool with the Tripos implementation of SIMCA.

The SIMCA model was generated using the default settings in the Tripos implementation of SIMCA (Wold, S. Analysis of Chemical Data in Terms of Analogy and Similarity, in Proc. First Int. Symp. on Data Analysis and Informatics, Versailles, France, 1977). All descriptors were considered with equal weighting to develop models with 2 to 29 components. Summaries of the models (Table 2) indicate the number of correctly categorized compounds for each oral bioavailability class. Criteria used to identify the best model were the total number of correctly categorized compounds with particular attention to Class 1 and Class 3 compounds. For completeness, five models were evaluated against the training set, also seen in Table 2.

The training set compounds are listed in Table 1. The experimental oral bioavailability values were taken from Goodman and Gilman (Goodman; Gilman: The Pharmacological Basis of Therapeutics, t. E., Hardman, et al. Eds. McGrawHill New York. 1996), when available. Otherwise, the Yoshida categorizations were used directly from the tables reported in their study. All structures were constructed and prepared in SYBYL; carboxylic acids and amines were charged when appropriate; the structures were assigned Gasteiger-Huckel charges (Gasteiger, J.; Marsili, M. Tet. 1980, 36; 3219-3222) and submitted to the MAXMIN molecular mechanics minimization (Clark, M.;. J. Comp. Chem. 1989, 10). Using SYBYL SPL scripts provided by Demeter (Demeter, D. A. Sybyl Spl Scripts for Computer Aided Drug Design. 1999), the entire database was submitted to single-point MOPAC (Stewart, J. J. P. Mopac 6.0 QCE Program #455, 1990), semi-empirical molecular orbital calculations: AMI Hamiltonian (Dewar, M. J. S. et al. J. Am. Chem. Soc. 1985, 107, 3902-3909), Coulson charges, and polarizability. From these calculations, Famini-type molecular orbital descriptors (Famini, G. R. Using Theoretical Descriptors in Structure Activity Relationships V. A Review of the Theoretical Parameters. CRDEC-TR-085, U.S. Army Chemical Research, 1989) were extracted and tabulated. In addition, other atom count and molecular descriptors were derived. The descriptors utilized are all tabulated in Table 3. The descriptors utilized are a blend of atom-, functional group, and molecule-based descriptors. No explicit inclusion of parameters are made based on known metabolic or toxicological processes in vivo. Rather, the parameters chosen are those that could logically be related to the various components of the overall oral bioavailability. For instance, electronic properties determined by the MOPAC calculations, are relatable to oxidative metabolic processes; size considerations, are important for membrane permeability and efflux mechanisms, etc.

The 8-component model was selected based upon a combination of the number of Class 1 and Class 3 correctly fit in the training set (Table 1), as well as the performance against the test set. In addition, the total number of allowed components at 8 assures that none of the oral bioavailability classes are over fit, a common concern with regression analyses. The model produces results that are comparable to the rates of fit produced by published models (Class 1 correct 64%; Class 3 correct 73%).

As seen in Table 3, this model yields the greatest reduction in data volume; 30 of the 52 compounds were predicted as Class 3 and would be retained in a production setting (42% data reduction). Of these 30 compounds, 18 of the 19 bona fide Class 3 compounds were correctly identified. Two Class 1 compounds incorrectly mis-stratified as Class 3, and one Class 3 compound was incorrectly mis-stratified as a Class 2 compound. The latter represents the sole false positive in the test set. As designed, the model shows the greatest error in the class 2 predictions; only eight of the 27 (˜30%) were correctly identified as Class 2, but most of the mis-stratified compounds in this class were regarded as permissible since they are either correctly eliminated or simply added to the list that was retained. As a final check of the validity of the final SIMCA model, the sum of the residuals for the respective class categories was monitored.

Smooth decreases in the sum of the residuals progressing from the 2- to 8 component models was found. No erratic or harmonic behavior was observed up to the 8-maximally allowed components thereby providing confidence that the additional components were adding true discriminatory power rather than model noise.

### EQUIVALENTS

Those skilled in the art will recognize, or be able to ascertain using no more than routine experimentation, many equivalents to the specific embodiments and methods described herein. Such equivalents are intended to be encompassed by the cope of the following claims.

All patents, patent applications, and literature references cited herein are hereby expressly incorporated by reference.

1. A method for determining the oral bioavailablity of a test molecule using SIMCA, comprising:
providing at least one descriptor for a test molecule;
allowing SIMCA to determine the classification of said test molecule, thus determining the oral bioavailability of said test molecule.

2. The method of claim 1, wherein at least four descriptors are provided.

3. The method of claim 2, wherein at least eight descriptors are provided.

4. The method of claim 3, wherein at least twelve descriptors are provided.

5. The method of claim 4, wherein at least twenty descriptors are provided.

6. The method of claim 5, wherein at least thirty descriptors are provided.

7. The method of claim 1, wherein at least one of said descriptors is selected from the group consisting of VOL, ATOMS, HHET, P, C, HBH, ZFIHET, ZHBH, and ZH.

8. The method of claim 1, wherein at least one of said descriptors is selected from the group consisting of MOB, EB, H, O, HBD, ZATOMS, ZC, ZO, ZHBA, ZHBD, and MORPHOLINE.

9. The method of claim 1, wherein at least one of said descriptors is selected from the group consisting of POLI, MOA, N, F, I, RING., HBA, ZN, MLOGP, HYDROXYL, and CF3.

10. The method of claim 1, wherein at least one of said descriptors is selected from the group consisting of EA, S, CL, BR, AMIDE, ACID, METHYL, METHOXY, PIPERDINE, PIPERAZINE, SULFONAMIDE, and PHENOL.

11. The method of claim 1, wherein said classification is divided into two or more classes based on oral bioavailability.

12. The method of claim 11, wherein said classification is divided into three or more classes.

13. The method of claim 12, wherein said classification is divided into three classes.

14. The method of claim 13, wherein the classes are 0-20%; 21-79%; and 81-100%.

15. The method of claim 1, wherein said classification is derived from a training set of ten or more compounds.

16. The method of claim 1, wherein said descriptor is a molecular orbital descriptor.

17. The method of claim 1, wherein said descriptor is a size based descriptor.

18. The method of claim 1, wherein said test molecule is not pre-classified according to structural class.

19. The method of claim 1, wherein the target tissue is the brain or central nervous system.

20. The method of claim 1, wherein the target tissue is blood accessible.
